(19) United States
(12) Patent Application Publication
(10) Pub. No.: US 2006/0098698 A1
(43) Pub. Date: May 11, 2006

(54) Frequency-converting lasers with non-linear materials optimized for high power operation

(75) Inventor: Mark A. Arbore, Los Altos, CA (US)

Correspondence Address: ALLEN, DYER, DOPPELT, MILBRATH & GILCHRIST P.A., 1401 CITRUS CENTER 255 SOUTH ORANGE AVENUE, P.O. BOX 3791, ORLANDO, FL, 32802-3791, US

(73) Assignee: Lightwave Electronics Corporation, Mountain View, CA (US)

(21) Appl. No.: 10/985,550

(22) Filed: Nov. 10, 2004

(51) Int. Cl. H01S 3/10

(52) U.S. Cl. 372/21

(57) ABSTRACT

A frequency-converted laser may be made with a non-linear material having a surface coated with an anti-reflection coating by measuring an absorbance of the anti-refection coating, and using the non-linear crystal for frequency conversion in the laser if the absorbance measured is less than a rejection threshold of about 100 parts-per-million or less.

### FIELD OF THE INVENTION

This invention generally relates to lasers and more particularly to making high power lasers that use non-linear crystals for frequency conversion.

### BACKGROUND OF THE INVENTION

Lithium Triborate (LiB₃O₅ or LBO) is an excellent nonlinear optical crystal discovered and developed by the Fuj ian Institute of Research on the Structure of Matter, Chinese Academy of Sciences. LBO is an example of a type of crystal known as Borates. The most important examples of borates include BBO (β-BaB₂O₄), LBO (LiB₃O₄) and CLBO (CsLiB₆O₁₀), all of which have found considerable use in the nonlinear conversion of light from infrared and visible lasers into the visible and UV spectral range. Among these crystals, LBO has become the crystal of choice for harmonic conversion of infrared radiation to visible and/or ultraviolet wavelengths because of a fortuitous combination of linear optical properties and nonlinear parameters. Lithium Triborate (LBO) single crystals combine unusually wide transparency, good refractive index homogeneity, adequately large nonlinear coupling, extremely high damage threshold, a short wavelength UV absorption edge, low (but non-zero) absorption, a wide phase-matching acceptance angle and small walk-off angle for many interactions, and good mechanical/chemical properties. In addition, LBO can support both type I and type II non-critical phase matched SHG in a wide wavelength range. Despite LBO's desirable optical properties and non-linear parameters, LBO crystals are subject to various problems. For example, LBO and other borate crystals can suffer deterioration in performance upon mere exposure to ambient environment, such as air. This is because the crystals are hygroscopic, and can chemically react with absorbed water molecules. Such reactions can cause undesirable alterations in the crystals' optical and physical properties.

Additional problems arise when LBO and other optical materials is exposed to high average optical powers, such as 100 Watts or greater. While the material may not catastrophically damage, it may suffer from thermal effects caused by low (but non-zero) levels of optical absorption. High-power frequency-converted laser systems could be made more reliable if the non-linear materials used for frequency conversion were less susceptible to such problems. Unfortunately, the nature of these problems has not been sufficiently explored in the prior art. Consequently, reliable techniques have not been developed for reducing the likelihood of all such problems associated with non-linear materials at high operating powers.

Thus, there is a need in the art, for a laser having a non-linear material for frequency conversion that is less susceptible to problems associated with high power operation and a method for making such a laser.

### SUMMARY OF THE INVENTION

Embodiments of the present invention overcome the disadvantages associated with the prior art where a surface of a non-linear material is coated with an anti-reflection coating by measuring an absorbance of the anti-refection coating, and using the non-linear crystal for frequency conversion in the laser if the absorbance measured is less than a rejection threshold of about 100 parts-per-million or less.

### BRIEF DESCRIPTION OF THE DRAWINGS

The teachings of the present invention can be readily understood by considering the following detailed description in conjunction with the accompanying drawings, in which:

FIG. 1 shows a schematic diagram of a laser according to an embodiment of the present invention;

FIG. 2 shows a schematic diagram of an intracavity-frequency tripled diode-pumped, laser according to an alternative embodiment of the present invention; and

FIGS. 3A-3B depict schematic diagrams illustrating extracavity-frequency tripled diode-pumped lasers according to other alternative embodiments of the present invention;

### DESCRIPTION OF THE SPECIFIC EMBODIMENTS

Although the following detailed description contains many specific details for the purposes of illustration, anyone of ordinary skill in the art will appreciate that many variations and alterations to the following details are within the scope of the invention. Accordingly, the exemplary embodiments of the invention described below are set forth without any loss of generality to, and without imposing limitations upon, the claimed invention.

### GLOSSARY

As used herein:

The article “A”, or “An” refers to a quantity of one or more of the item following the article, except where expressly stated otherwise.

Cavity refers to an optical path defined by two or more reflecting surfaces along which light can reciprocate or circulate. Objects that intersect the optical path are said to be within the cavity.

Continuous wave (CW) laser: A laser that emits radiation continuously rather than in short bursts, as in a pulsed laser.

Diode Laser refers to a light-emitting diode designed to use stimulated emission to generate a coherent light output. Diode lasers are also known as laser diodes or semiconductor lasers.

Diode-Pumped Laser refers to a laser having a gain medium that is pumped by a diode laser.

Gain Medium refers to a lasable material as described below with respect to Laser.

Garnet refers to a particular class of oxide crystals, including e.g., yttrium aluminum garnet (YAG), gadolinium gallium garnet (GGG), gadolinium scandium gallium garnet (GSGG), yttrium scandium gallium garnet (YSGG) and the like.

Includes, including, e.g., “such as”, “for example”, etc., “and the like” may, can, could and other similar qualifiers used in conjunction with an item or list of items in a particular category means that the category contains the item or items listed but is not limited to those items.

Infrared Radiation refers to electromagnetic radiation characterized by a vacuum wavelength between about 700 nanometers (nm) and about 5000 nm.

Laser is an acronym of light amplification by stimulated emission of radiation. A laser is a cavity that is filled with lasable material. This is any material—crystal, glass, liquid, dye or gas—the atoms of which are capable of being excited to a metastable state by pumping e.g., by light or an electric discharge. The light emitted by an atom as it drops back to the ground state and emits light by stimulated emission The light (referred to herein as stimulated radiation) is continually increased in intensity as it makes multiple round trips through the cavity. A laser may be constructed using an optical fiber as the gain medium. Fibers are typically glass-type materials, though may be crystalline or glass-nano-crystal composites.

Light: As used herein, the term “light” generally refers to electromagnetic radiation in a range of frequencies running from infrared through the ultraviolet, roughly corresponding to a range of vacuum wavelengths from about 1 nanometer (10⁻⁹ meters) to about 100 microns.

Mode-Locked Laser refers to a laser that functions by controlling the relative phase (sometimes through modulation with respect to time) of each mode internally to give rise selectively to energy bursts of high peak power and short duration, e.g., in the picosecond (10⁻¹² second) domain.

Non-linear effect refers to a class of optical phenomena that can typically be viewed only with nearly monochromatic, directional beams of light, such as those produced by a laser. Harmonic generation (e.g., second-, third-, and fourth-harmonic generation), optical parametric oscillation, sum-frequency generation, difference-frequency generation, optical parametric amplification, and the stimulated Raman effect are examples.

Non-linear material refers to materials that possess a non-zero nonlinear dielectric response to optical radiation that can give rise to non-linear effects. Examples of non-linear materials include crystals of lithium niobate (LiNbO₃), lithium triborate (LiB₃O₅ or LBO), beta-barium borate (BBO), Cesium Lithium Borate (CLBO), potassium dihydrogen phosphate (KDP) and its isomorphs, LiIO₃ crystals, potassium titanyl phosphate (KTP) as well as quasi-phase-matched materials.

Phase-matching refers to the technique used in a multiwave nonlinear optical process to enhance the distance over which the coherent transfer of energy between the waves is possible. For example, a three-wave process is said to be phase-matched when k₁+k₂=k₃, where kᵢ is the wave vector of the i^{th} wave participating in the process. In frequency doubling, e.g., the process is most efficient when the fundamental and the second harmonic phase velocities are matched.

Q refers to the figure of merit of a resonator (cavity), defined as (2π)×(average energy stored in the resonator)/(energy dissipated per cycle). The higher the reflectivity of the surfaces of an optical resonator and the lower the absorption losses, the higher the Q and the less energy loss from the desired mode.

Q-switch refers to a device used to rapidly change the Q of an optical resonator.

Q-switched Laser refers to a laser that uses a Q-switch in the laser cavity to prevent lasing action until a high level of inversion (optical gain and energy storage) is achieved in the lasing medium. When the switch rapidly increases the Q of the cavity, e.g., with an acousto-optic or electrooptic modulators or saturable absorbers, a giant pulse is generated.

Quasi-Phase-matched (OPM) Material: In a quasi-phase-matched material, the fundamental and higher harmonic radiation are not phase-matched, but a QPM grating compensates. In a QPM material, the fundamental and higher harmonic can have identical polarizations, often improving efficiency. Examples of quasi-phase-matched materials include periodically-poled lithium tantalate, periodically-poled lithium niobate (PPLN) or periodically-poled potassium titanyl phosphate (PPKTP).

Vacuum Wavelength: The wavelength of electromagnetic radiation is generally a function of the medium in which the wave travels. The vacuum wavelength is the wavelength electromagnetic radiation of a given frequency would have if the radiation were propagating through a vacuum and is given by the speed of light in vacuum divided by the frequency.

Introduction

In general terms, embodiments of the present invention produce frequency-converting lasers with non-linear crystals that are optimized for high power operation. The inventor has been involved in a study of problems in lasers that use non-linear materials as a frequency-converting medium. In particular their studies have focused on intracavity frequency-tripled lasers using lithium triborate (LBO). The inventors believe that their discoveries can be applied to other types of frequency-converted lasers and other solid-state lasers as well. Without being limited to any particular scientific explanation, the following discussion illustrates some of the problems associated with LBO.

A frequency converted laser uses a non-linear material such as LBO to convert the frequency of primary radiation produced by lasing in a gain medium. The optical properties of the non-linear material depend in part on temperature. For continuous wave operation at constant power, the nonlinear medium can achieve a thermal equilibrium within a few seconds. For such operation LBO is regarded as a nearly ideal non-linear material. However, when the laser is operated in a bursted or pulsed mode, with transient time scales on the order of several milliseconds or less, the thermal properties of LBO can cause serious drawbacks. Specifically, LBO has a low thermal conductivity and a very high heat capacity. Consequently, even though LBO absorbs very little radiation in the bulk, the radiation that is absorbed tends to heat the LBO with a time constant of order several seconds. In addition, the thermal coefficient of expansion of LBO is very large and highly anisotropic. Specifically, LBO has a thermal expansion coefficient of +108 ppm/K along one crystal axis and −88 ppm/K along another different crystal axis. This means that as the LBO is heated it expands in one direction and compresses in another. In addition, because the beam is typically much narrower than the LBO crystal, not all portions of the LBO are heated at the same rate. Consequently, due to non-uniform heating, the LBO can experience thermal stresses. Thermal stresses can lead to undesirable lens effects in the LBO.

Laser manufacturers often specify criteria for rejecting non-linear materials based on the total optical absorption of a non-linear material. However, the criteria are often arbitrary. Furthermore, as the inventors have determined, the total optical absorption is not the best indicator of the likelihood of absorption-related problems. The total absorption is actually a sum of absorptions due to different phenomena. The total absorption depends on, among other things, the bulk absorption of the non-linear material, absorption due to impurities, surface contamination, surface polish and absorption by surface coatings.

The optical surfaces of non-linear materials used in frequency-converting lasers are often coated. For example, LBO crystals are often anti-reflection (AR) coated to prevent back reflections from the input and output surfaces of the crystals. The design of these coatings can be constrained by the fact that such coatings can be difficult to adhere to LBO due to the large and anisotropic thermal expansion of the LBO. The loss of AR coatings is, in general, the sum of the losses due to absorption and the reflection. Since reflections are typically about 0.1% to about 1%, optical absorptions of 0.01% and less by such coatings typically account for a relatively small fraction of what is often a very small loss to begin with. Consequently, the optical absorption due to such coatings has, to the inventor's knowledge, been ignored as a criterion for accepting or rejecting non-linear materials.

The inventor also recognized that an additional drawback associated with AR coatings is that if the coating absorbs even a relatively small amount of radiation the LBO is likely to suffer from thermal effects of the type described above. This is believed to be a consequence of localized heating at the surface due to absorption of radiation by the AR coating. Since heated surfaces of the LBO are less constrained to expand or contract compared to interior portions, heated LBO surfaces can develop surface bulges in vicinity of beam. Thus, thermal stresses resulting from optical absorption by coatings on optical surfaces of the LBO crystal can lead to undesirable lens effects in the LBO. This may be the case even though the optical absorption by the coating is only a small fraction of the total absorption.

Pulsed operation of lasers (as opposed to continuous wave (CW) operation) is often implemented using modelocked or Q-switched lasers on order to obtain high peak powers for frequency conversion in non-linear materials. The output is sometimes pulsed by pulsing the pumping energy applied to the laser gain medium. The inventor has also observed that the effects of optical absorption by AR coatings are particularly problematic for non-linear materials such as LBO that are subject to transient pulses or bursts of radiation of about 10 milliseconds or less.

Experiments

An analysis of optical absorption of AR coatings and thermal transient related problems in LBO crystals revealed that failure occurred less frequently for AR-coated LBO crystals when the AR coatings had an absorption coefficient less than about 100 parts-per-million. Failure occurred significantly less frequently for AR-coated LBO crystals when the AR coatings had an absorption coefficient less than about 35 parts-per-million.

For these experiments LBO crystals were obtained from Fujian Castech of Fuzhou, Fujian China. The LBO crystals were coated with multi-layer dielectric AR coatings and were subjected to power transients upon burst-mode initiation. In this mode the coatings were subjected to a burst of short duration pulses of 1064-nm wavelength laser radiation with the burst lasting a few milliseconds with the pulses turned off for a few milliseconds between bursts of pulses. Optical absorption of the AR coatings was studied using photo-thermal common-path interferometry (PCI) using a system supplied and operated by Stanford Photothermal Solutions of Los Gatos Calif. The PCI technique operates in a “pump-probe” configuration, and is sensitive to optical absorption at the ppm/cm level. A pump beam and a probe beam intersect with each other and with the sample. Localized heating of the sample due to optical absorption of the pump beam has an effect the probe beam. This effect can be correlated to the optical absorption. Since the probe and pump beams intersect over a relatively narrow region, optical absorption can be spatially resolved over the sample.

Solution to the Problem

As a result of these experiments the inventor has devised method to reduce the incidence of problems in non-linear materials associated with optical absorption by AR or other surface coatings. According to embodiments of the method a measured optical absorption of the surface coating on a non-linear material serves as an acceptance criteria for use of the non-linear material in a frequency-converted laser. The optical absorption of the coating on a non-linear material is measured and the material is used in a laser if the coating has an optical absorption less than about 100 parts-per-million (ppm), more preferably less than about 35 ppm and still more preferably less than about 10 ppm in some wavelength rage of interest. The absorption of the coatings can be measured by the supplier of the non-linear materials, the user (e.g., a laser manufacturer) or by a third party. Preferably, the optical absorption is measured before the non-linear material is used in a frequency-converted laser.

### DETAILED DESCRIPTION OF THE DRAWINGS

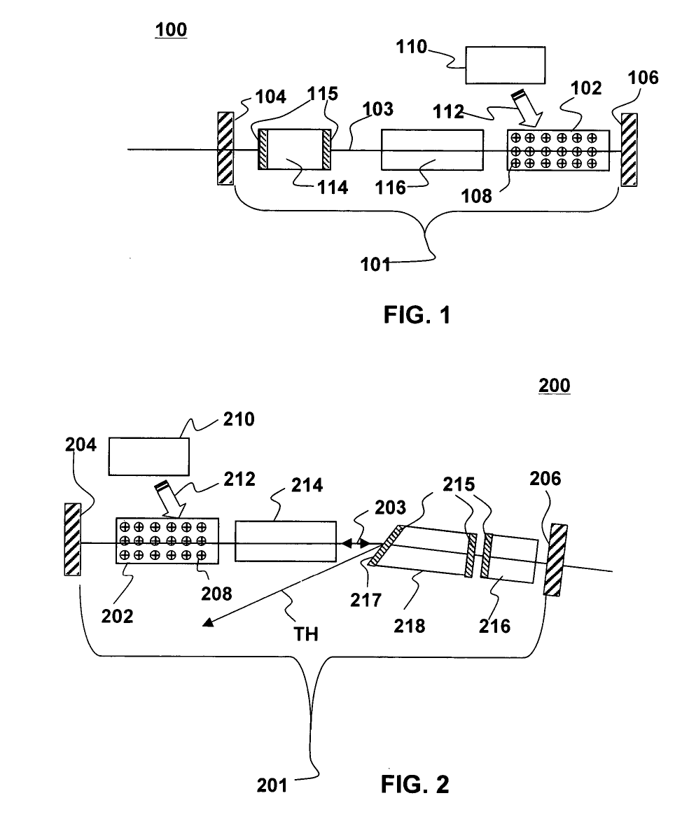

FIG. 1, and FIGS. 2A-2B depict examples of lasers according to embodiments of the present invention. FIG. 1 shows a laser 100, having a gain medium 102 and a non-linear material 114 disposed within a cavity 101 defined by reflecting surfaces 104, 106. The gain medium 102 may be doped with dopant ions 108 that provide a metastable state for lasing.

The cavity 101 is configured to support electromagnetic radiation 103, e.g., stimulated radiation from the gain medium 102, characterized by a fundamental frequency ω chosen such that the radiation 103 falls within the infrared portion of the electromagnetic spectrum. In a preferred embodiment, the fundamental frequency ω corresponds to a vacuum wavelength of about 1064 nm. In alternative embodiments, the fundamental frequency ω can correspond to a vacuum wavelength of about 914, nm, 946 nm or 1319 nm, 1343 nm or other wavelength known in the art. The cavity 101 may be configured, e.g., by choosing the dimensions (e.g. radii), reflectivities and spacing of the reflectors 104, 106 such that the cavity 101 is a resonator capable of supporting radiation of the fundamental frequency ω. Although a linear cavity 101, having two reflecting surfaces is depicted in FIG. 1, those of skill in the art will be able to devise other cavities, e.g., having stable, unstable, 3-mirror, 4-mirror Z-shaped, 5-mirror W-shaped, cavities with more legs, ring-shaped, or bowtie configurations being but a few of many possible examples.

The gain medium 102 is preferably a solid-state material, such as a crystalline material or a glass. The gain medium 102 can have a length of between about 1 mm and about 200 mm if it is crystalline or bulk glass in nature. If the gain medium is a fiber, then it is typically much longer, from about 0.1 meters to several hundred meters. Preferable crystalline materials include oxides and fluoride crystals, such as yttrium lithium fluoride (YLF). Oxide crystals include YALO (YAlO₃), yttrium orthovanadate (YVO₄) and garnets. Suitable garnets include yttrium aluminum garnet (YAG), gadolinium gallium garnet (GGG), gadolinium scandium gallium garnet (GSGG), and yttrium scandium gallium garnet (YSGG). A preferred garnet is YAG, which can be doped with different ions. Preferred doped YAG crystals include Tm:Ho:YAG, Yb:YAG, Er:YAG and Nd:YAG, Nd:YVO₄ and Nd:YALO. Crystalline gain media containing suitable co-dopant ions can be fabricated by introducing the co-dopant into the melt as the crystal is being grown. This is often implemented using the well-known Czochralski growth method.

The gain medium 102 is most preferably Yttrium Aluminum Garnet doped with Nd³⁺ dopant ions 108 (Nd³⁺:YAG). By way of example, the gain medium 102 may be a Nd-YAG Brewster rod having a 1% Nd-dopant level. Nd³⁺:YAG produces stimulated emission at vacuum wavelengths of about 946 nm, about 1064 nm, and about 1319 nm, among others. Other suitable gain media include, those listed above, which may be of various shapes and sizes and with higher or lower co-dopant levels. Nd:YAG and other gain media are commercially available, e.g., from VLOC of New Port Richie, Fla.

The gain medium 102 may have two end surfaces through which the fundamental radiation 103 passes. The end surfaces of the gain medium 102 may be normal (perpendicular) or near normal to the direction of propagation of the fundamental radiation 103 as shown in FIG. 1. Alternatively, the end surfaces may be situated at a Brewster's angle θ_{B} relative to the fundamental radiation 103, such that the fundamental radiation 103 is p-polarized with respect to the end surfaces, i.e. polarized in the plane of the plane of incidence of the fundamental radiation 103. Alternatively, end surfaces may be polished at some other angle.

The gain medium 102 may be pumped (e.g., end-pumped or side-pumped) by an external source 110 of pumping energy 112. An interaction between the pumping energy 112 and the gain medium 102 produces the radiation 103. As such, the radiation 103 is, at least initially, internal radiation. The pumping energy 112 may be in the form of radiation introduced through one or more sides and/or ends of the gain medium 102. In a preferred embodiment, the external source 110 is a diode laser, in which case the laser 100 would be a diode-pumped laser. The pumping radiation 112 can have a vacuum wavelength ranging from about 650 nm to about 1550 nm. For Nd:YAG, the pumping radiation is typically at a vacuum wavelength of about 808 nm or about 880 nm.

The non-linear material 114 may be e.g., a non-linear crystal such as LBO. Non-linear materials may be used in conjunction with frequency conversion, e.g., generation of higher or lower harmonics of the fundamental radiation produced by a gain medium. Examples of particular interest include frequency-doubling and frequency-tripling. By way of example, the non-linear material 114 may be phase-matched for second harmonic generation (frequency doubling), which produces radiation of frequency 2ω from the fundamental radiation 103 of fundamental, corresponding, e.g., to a wavelength of about 532 nm. The non-linear material 114 may be located either within the cavity or outside of it. In cases where the non-linear material is located within the cavity, as shown in FIG. 1, the laser 100 is sometimes referred to as an intracavity frequency-converted laser.

The non-linear material 114 has one or more surfaces coated with a coating 115, such as an AR coating. Suitable non-linear materials (such as LBO crystals) are available with AR coatings, e.g., from Fujian Castech Crystals of Fujian, China. As described above, the coating 115 desirably has a measured optical absorption less than about 100 ppm, preferably less than about 35 ppm and more preferably less than about 10 ppm. The optical absorption of the coating 115 may be measured by a technique available from Stanford Photothermal Solutions of Los Gatos, Calif. LBO crystals with AR coatings having an optical absorption within the desired range are particularly useful where the total optical power through the non-linear material 115 is greater than about 100 watts, more preferably, greater than about 1000 watts. The total optical power may be a circulating power in the case of an intracavity frequency-converted laser or a total output power in the case of an externally frequency-converted laser.

The laser 100 may optionally include a pulsing mechanism 116 that facilitates generation of high-intensity radiation pulses (e.g. a Q-switch, a modelocker, passive saturable absorber, a gain control device or some combination thereof). In particular embodiments the pulsing mechanism is a Q-switch. The Q-switch may be an active Q-switch (e.g., using an electro-optic or acousto-optic modulator), or a passive Q-switch (e.g., using a saturable absorber). In other embodiments, the output of the laser 100 may be pulsed by pulsing the source 110 of pumping energy 112. For example, in the case of a laser diode as the source 110, the pumping radiation 112 may be pulsed by pulsing the laser diode current. Pulsed operation of the laser 100 can contribute to the type of problems described above. However, if the coating 115 has an optical absorption in the desired range, the non-linear material 114 may be less susceptible to problems resulting from high peak intensities even if the pulsing mechanism 116 produces transient pulses or bursts of radiation of about 10 milliseconds or less in duration.

Other variations on the laser of FIG. 1 include lasers that contain more than one section of gain material, more than one type of gain material, or more than one non-linear material. For example, FIG. 2 depicts a schematic diagram of an intracavity frequency-tripled laser 200 according to an alternative embodiment of the present invention. The laser 200 includes a gain medium 202 and pulsing mechanism 214 disposed within a cavity 201 defined by reflecting surfaces 204, 206. The gain medium 202 may include dopant ions 208 that provide a metastable state. The cavity 201, gain medium 202, reflecting surfaces 204, 206, ions 208, and pulsing mechanism 214 may be as described above with respect to the corresponding components in laser 100 of FIG. 1. The laser 200 may further include a source 210 of pump radiation 212, which may be as described above.

The pump radiation 212 stimulates emission by the gain medium 202 of fundamental radiation 203 having frequency ω, corresponding e.g., to a wavelength of about 1064 nm. The laser 200 further includes first and second non-linear elements 216, 218, e.g., non-linear crystals such as LBO, disposed within the cavity 201. The first non-linear element 216 is phase-matched for second harmonic generation, which produces radiation of frequency 2ω, corresponding, e.g., to a wavelength of about 532 nm. The second non-linear element 218 is phase-matched for sum frequency generation between the fundamental radiation and the second harmonic radiation to produce third harmonic radiation TH of frequency 3ω, corresponding, e.g., to a wavelength of about 355 nm. The second non-linear element 218 may include a Brewster-cut face 217. Third harmonic radiation TH emerging from the second non-linear element through the Brewster-cut face 217 refracts out of the cavity 201 as output radiation from the laser. Fundamental radiation 203 remains within the cavity 201.

The first and second non-linear elements 216, 218 include coatings 215 (e.g., AR coatings) on one or more faces through which radiation passes. The optical coatings 215 desirably have a measured optical absorption less than about 100 ppm, preferably less than about 35 ppm and more preferably less than about 10 ppm.

The operation of frequency-tripled lasers such as that shown in FIG. 2 is described in detail, e.g., in commonly-assigned U.S. Pat. No. 5,850,407, which is incorporated herein by reference.

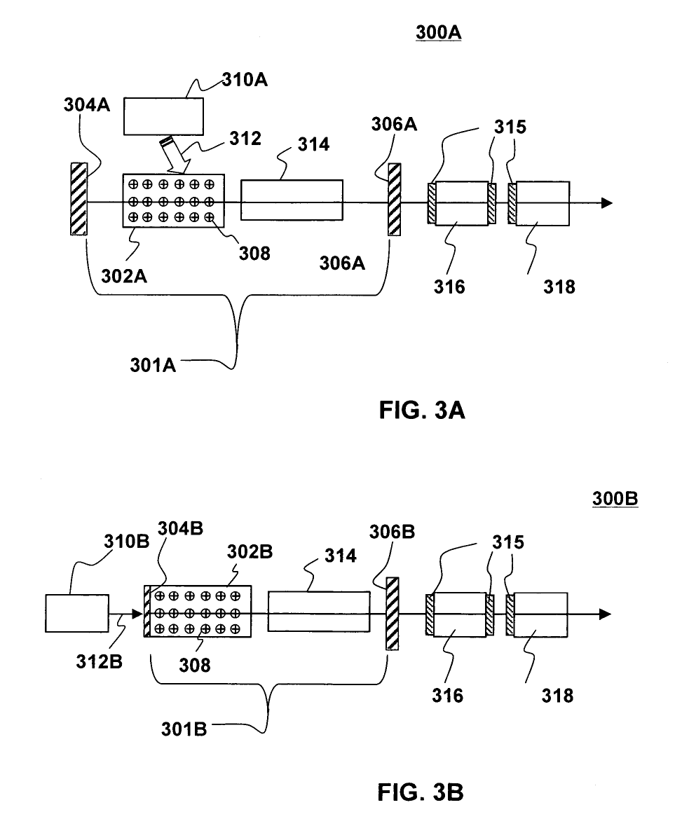

In the laser of FIG. 2, the frequency tripling occurs within the laser. Alternatively, a frequency-tripled laser may be made using a laser of the type shown in FIG. 1 with the frequency tripling occurring outside the laser cavity. Examples of such lasers are depicted in FIG. 3A and FIG. 3B.

FIG. 3A depicts an externally frequency-tripled laser 300A having a gain medium 302A and pulsing mechanism 314 disposed within a cavity 301A defined by reflecting surfaces 304A, 306B. The gain medium 302A may include dopant ions 308 as described above. The cavity 301, gain medium 302, reflecting surfaces 304A, 306B, ions 308, and pulsing mechanism 314 may be as described above with respect to the corresponding components in laser 100 of FIG. 1. The laser 300A may further include a source 310A of pump radiation 312, which may be a diode laser as described above.

One of the reflecting surfaces, e.g. surface 306B, is partially (e.g., about 50% to about 99%) reflecting with respect to and serves as an output coupler. The laser 300A further includes first and second non-linear elements 316, 318 disposed outside the cavity. The first and second non-linear elements are phase-matched as described above to produce third-harmonic radiation TH from the stimulated radiation from the gain medium 302A that emerges from the output coupler 306A. Because of the external configuration of the non-linear crystals 316, 318, they need not have Brewster-cut faces. The ultra-low loss of a Brewster face is not as important, though still of some value, with respect to wavelength separation. A higher intensity in e.g., LBO is required for higher conversion efficiency (e.g., greater than about 20%). Thus, focusing into LBO or short pulses with high intensities may be needed.

The first and second non-linear elements 316, 318 include coatings 315 (e.g., AR coatings) on one or more surfaces through which radiation passes. The optical coatings 215 desirably have a measured optical absorption less than about 100 ppm, preferably less than about 35 ppm and more preferably less than about 10 ppm.

FIG. 3B depicts another frequency tripled laser 300B, which is a variation on the laser of FIG. 3A. Like laser 300A, laser 300B has a gain medium 302B and pulsing mechanism 314 disposed within a cavity 301B defined by reflecting surfaces 304B, 306B. The gain medium 302B may include dopant ions 308 as described above. The laser 300B further includes a source 310B of pump radiation 312, which may be a diode laser as described above. The laser 300B also includes first and second non-linear elements configured for frequency tripling of stimulated emission from the gain medium 302B that emerges from the output coupler 306B. Like laser 300A, one of the reflecting surfaces (306B) serves as an output coupler. Unlike the laser 300A, the other reflecting surface 304B also serves as an input coupler for the pumping radiation 312. When used as an input coupler, the reflecting surface 304B is transmissive to the pump radiation 312 and reflective to stimulated emission from the gain medium 302B. The reflecting surface/input coupler 304B may also coincide with one of the end faces of the gain medium 302B.

The first and second non-linear elements 316, 318 include coatings 315 (e.g., AR coatings) on one or more faces through which radiation passes. The optical coatings 215 desirably have a measured optical absorption less than about 100 ppm, preferably less than about 35 ppm and more preferably less than about 10 ppm.

Embodiments of the present invention allow for higher performance of commonly available high intensity lasers without having to completely re-engineer an existing design. Thus, a whole new class of high performance lasers can be made commercially available without compromising other performance parameters.

While the above is a complete description of the preferred embodiment of the present invention, it is possible to use various alternatives, modifications and equivalents. Therefore, the scope of the present invention should be determined not with reference to the above description but should, instead, be determined with reference to the appended claims, along with their full scope of equivalents. The appended claims are not to be interpreted as including means-plus-function limitations, unless such a limitation is explicitly recited in a given claim using the phrase “means for.”

What is claimed is:

1. A method for making a frequency converted laser with a non-linear material having surface coated with a coating, the method comprising the step of:
using the non-linear crystal for frequency conversion in the laser if a measured absorbance of the coating is less than a rejection threshold of about 100 parts-per-million.

2. The method of claim 1 further comprising the step of measuring an absorbance of the anti-refection coating.

3. The method of claim 2 wherein measuring an absorbance of the coating includes the use of photothermal common-path interferometry.

4. The method of claim 1 wherein the non-linear material is a crystalline material.

5. The method of claim 2 wherein the non-linear crystal is lithium triborate (LBO).

6. The method of claim 1 wherein the rejection threshold is less than about 35 parts-per-million.

7. The method of claim 4 wherein the rejection threshold is less than about 10 parts-per-million.

8. The method of claim 1 wherein an optical power through the non-linear material during operation of the laser is greater than about 100 watts.

9. The method of claim 6 wherein the optical power through the non-linear material during operation of the laser is greater than about 1000 watts.

10. The method of claim 1 wherein the coating is an anti-reflection coating.

11. A frequency converted laser, comprising:
an optical cavity having one or more reflecting surfaces;
a gain medium disposed along an optical path within the optical cavity; and
one or more non-linear materials optically coupled to the gain medium, wherein one or more of the non linear materials has a surface with a coating, wherein the coating has an optical absorption of less than about 10 parts per million.

12. The laser of claim 11, further comprising a pulsing mechanism optically coupled to the gain medium, wherein, during operation of the laser, the pulsing mechanism pulses radiation from the gain medium to produce transient pulses or bursts of radiation of about 10 milliseconds duration or less.

13. The laser of claim 11 wherein the non-linear material is lithium triborate (LBO).

14. The laser of claim 11 wherein an optical power through the one or more non-linear materials during operation of the laser is greater than about 100 watts.

15. The laser of claim 14 wherein the optical power through the one or more non-linear materials during operation of the laser is greater than about 1000 watts.

16. The laser of claim 11 wherein the non-linear material is disposed along an optical path within the optical cavity.

17. The laser of claim 11 wherein at least one of the one or more non-linear materials is disposed along an optical path outside the cavity.

18. The laser of claim 11 wherein at least one of the one or more non-linear materials is phase-matched to generate second harmonic radiation from a fundamental radiation from the gain medium.

19. The laser of claim 18 wherein the one or more non-linear materials further includes a second non-linear material that is phase-matched to produce a third harmonic radiation from the fundamental radiation and the second harmonic radiation.

20. The laser of claim 11 wherein the coating is an anti-reflection coating.
